(19) United States
(12) Patent Application Publication
(10) Pub. No.: US 2015/0317609 A1
(43) Pub. Date: Nov. 5, 2015

(54) COMPANY PERSONNEL ASSET ENGINE

(71) Applicant: LinkedIn Corporation, Mountain View, CA (US)

(72) Inventors: Vaibhav Goel, Mountain View, CA (US); Suman Sundaresh, Cupertino, CA (US); Satpreet Harcharan Singh, Mountain View, CA (US)

(21) Appl. No.: 14/300,312

(22) Filed: Jun. 10, 2014

Related U.S. Application Data
(60) Provisional application No. 61/986,613, filed on Apr. 30, 2014.

(51) Int. Cl. G06Q 10/10; G06Q 50/00; H04L 29/08

(52) U.S. Cl. CPC G06Q 10/1053; H04L 67/306; G06Q 50/01

(57) ABSTRACT

A system maintains one or more of member profiles, company profiles, and job postings on a social networking service. The system identifies a business organization using the one or more of member profiles, company profiles, and job postings. The system identifies a job title or a job function at the business organization using the one or more of member profiles, company profiles, and job postings. The system also identifies a number of employees in the job title or job function at the business organization using one or more of the member profiles and the company profiles. The system determines a number of years that each employee has been employed in the job title or job function for the business organization using at least the member profiles, and calculates an average time period that a typical employee has been in the job title or job function for the business organization.

### PRIORITY

This patent application claims the benefit of priority to U.S. Provisional Patent Application Ser. No. 61/986,613, filed on Apr. 30, 2014, which is incorporated herein by reference in its entirety.

### TECHNICAL FIELD

The subject matter disclosed herein generally relates to a system and method for analyzing companies and business organizations using online profile data.

### BACKGROUND

Data and information relating to companies and business organizations are provided by the companies and business organizations and include company reports and other such information. However, such data and information have historically been limited to information that the company chooses to disclose, or data and information that the companies have to disclose as required by law (such as required by the U.S. Securities and Exchange Commission). As a result, this information may not give a complete picture of the company, and for some purposes does not provide useful information.

### BRIEF DESCRIPTION OF THE DRAWINGS

Some embodiments are illustrated by way of example and not limitation in the figures of the accompanying drawings.

FIG. 1 is a block diagram of a system including user devices and a social network server.

FIG. 2 is a block diagram illustrating various components of a social networking server.

FIG. 3 is a block diagram showing some of the functional components or modules that comprise a processing engine.

FIG. 4A is a user interface illustrating a list of companies wherein a user profile is similar to the employee profile of the companies.

FIG. 4B is a user interface illustrating a job profile for a job title or job function at a business organization, wherein the job profile was created using member profiles and job profiles.

FIG. 4C is a user interface that displays an average time period that a typical employee has had a particular job title or job function for a business organization.

FIGS. 5A and 5B are a block diagram illustrating features and operations of a process and system for recommending to a user of a social networking service a job posted by a business organization when an employee profile for the business organization is similar to a profile of the user.

FIGS. 6A and 6B are a block diagram illustrating features and operations of a process and system for creating a job profile for a particular job title or job function at a business organization using member profiles and job profiles.

FIGS. 7A and 7B are a block diagram illustrating features and operations of a process and system for calculating an average time period that a typical employee has had a particular job title or job function for a business organization.

FIG. 8 is a block diagram illustrating components of a machine able to read instructions from a machine-readable medium.

### DETAILED DESCRIPTION

Example methods and systems are directed to recommending a job posted by a business organization to a user of a social networking service when an employee profile for the business organization is similar to a profile of the user. Example methods and systems are also directed to creating a job profile for a particular job title or job function at a business organization using job profiles of the business organization and member profiles. Example methods and systems are further directed to calculating an average time period that a typical employee has had a particular a job title or job function for a business organization. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

While broad dissemination of company data and information via company-originated reports and brochures is known, such reports and brochures may not contain the data and information that some people truly want about a company. For example, a person who is looking for employment at a particular company, or a job recruiter working for or with a particular company, may not be too interested in the financial details of the company (about which many a company-originated document is focused). Additionally, while a stock analyst may find the financial details of the company interesting, these data are available to everyone, and therefore knowing these data does not provide an advantage to any one particular analyst. Moreover, a particular analyst may truly desire other information about the company, but may simply not be able to acquire such information. Consequently, a system has been developed that recommends to a user of a social networking service a job posted by a business organization when an employee profile for the business organization is similar to a profile of the user, creates a job profile for a particular job title or job function at a business organization using member profiles and job profiles, and/or calculates an average time period that a typical employee has had a particular job title or job function for a business organization. In this way, a user or member of a social networking service may receive additional pertinent data and information about a particular company.

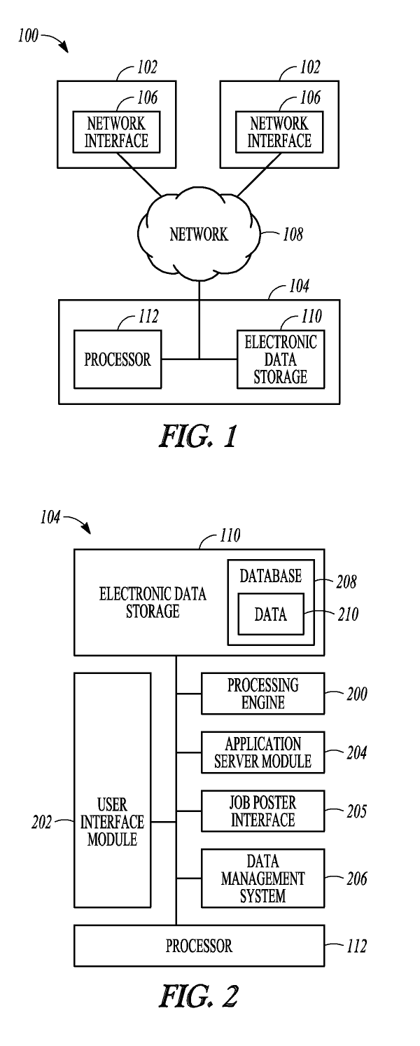

FIG. 1 is a block diagram of a system 100 including user devices 102 and a social network server 104. In an embodiment, a particular type of social network server can be referred to as a business network server. User devices 102 can be a personal computer, netbook, electronic notebook, smartphone, or any electronic device known in the art that is configured to display web pages. The user devices 102 can include a network interface 106 that is communicatively coupled to a network 108, such as the Internet.

The social network server 104 can be communicatively coupled to the network 108. The server 104 can be an individual server or a cluster of servers, and can be configured to perform activities related to serving the social network, such as storing social network information, processing social network information according to scripts and software applications, transmitting information to present social network information to users of the social network, and receive information from users of the social network. The server 104 can include one or more electronic data storage devices 110, such as a hard drive, and can include a processor 112.

The social network server 104 can store information in the electronic data storage device 110 related to users and/or members of the social network, such as in the form of user characteristics corresponding to individual users of the social network. For instance, for an individual user, the user's characteristics can include one or more profile data points, including, for instance, name, age, gender, profession, prior work history or experience, educational achievement, location, citizenship status, leisure activities, likes and dislikes, and so forth. The user's characteristics can further include behavior or activities within and without the social network, as well as the user's social graph. For an organization, such as a company, the information can include name, offered products for sale, available job postings, organizational interests, forthcoming activities, and the like. For a particular available job posting, the job posting can include a job profile that includes one or more job characteristics, such as, for instance, area of expertise, prior experience, pay grade, residency or immigration status, and the like.

The ability to accurately process in real-time or essentially real-time a recommendation to a user of a social networking service a job posted by a business organization when an employee profile for the business organization is similar to a profile of the user, a creation of a job profile for a particular job title or job function at a business organization using member profiles and job profiles, and/or a calculation of an average time period that a typical employee has had a job title or job function for a business organization, can be achieved with a general processing engine. Accordingly, at least in some examples, the general processing engine provides a recommendation service, a creation service, or a calculation service that can be customized for use with multiple applications or services. A processing entity can be a collection of information organized around a particular concept that is supported by the system 100 in general, such as similarity of a business organization's employee profile and the profile of a member, the creation of a particular job profile for a particular job title at a business organization, and/or a calculation of an average time that a typical employee has had a typical job title at the business organization.

The general processing engine may execute in real-time or as a background operation, such as offline or as part of a batch process. In some examples that incorporate relatively large amounts of data to be processed, the general processing engine may execute via a parallel or distributed computing platform.

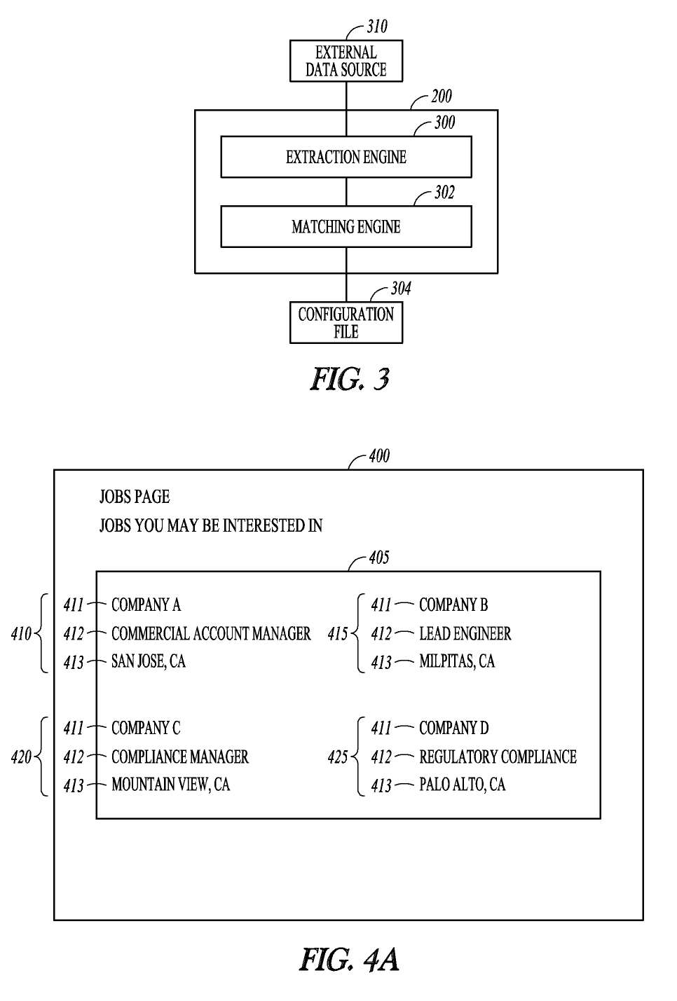

FIG. 2 is a block diagram illustrating various components of a social networking server 104 with a processing engine 200 for identifying similarities between different processing entity types and other processing, such as identifying similarities of a business organization's employee profile and the profile of a member, creating a particular job profile for a particular job title at a business organization, and/or calculating an average time that a typical employee has had a typical job title at the business organization. In an example, the social networking server 104 is based on a three-tiered architecture, consisting of a front-end layer, application logic layer, and data layer. As is understood by skilled artisans in the relevant computer and Internet-related arts, each module or engine shown in FIG. 2 can represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social networking server 104 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end of the social network server 104 consists of a user interface module (e.g., a web server) 202, which receives requests from various client computing devices, and communicates appropriate responses to the requesting client devices. For example, the user interface module(s) 202 may receive requests in the form of Hypertext Transport Protocol (HTTP) requests, or other web-based, application programming interface (API) requests. The application logic layer includes various application server modules 204, which, in conjunction with the user interface module(s) 202, generates various user interfaces (e.g., web pages) with data retrieved from various data sources in the data layer. With some embodiments, individual application server modules 204 are used to implement the functionality associated with various services and features of the system 100. For instance, the ability to calculate an average time that a typical employee has had a particular job title at the business organization may be a service implemented in an independent application server module 204. Similarly, other applications or services that utilize the processing engine 200 may be embodied in their own application server modules 204.

The data layer 110 can include several databases, such as a database 208 for storing data 210 such as job profiles, general employee profiles, specific employee profiles, company profiles, and job postings, and can further include additional social network information, such as interest groups, companies, advertisements, events, news, discussions, tweets, questions and answers, and so forth. In some examples, the data are processed in the background (e.g., offline) to generate pre-processed data that can be used by the processing engine, in real-time, and to make recommendations or report results generally. In an example, the processing engine 200 may recommend to a user of a social networking service a job posted by a business organization when an employee profile for the business organization is similar to a profile of the user. In another example, the processing engine 200 may create a job profile for a particular job title or job function at a business organization using job profiles of the business organization and member profiles (of the social networking service). In yet another example, the job processing engine 200 may calculate an average time period that a typical employee has had a job title or job function for a business organization. These examples merely typify possible variations.

In various examples, when a person initially registers to become a user (and/or member) of the system 100, the person can be prompted to provide some personal information, such as his or her name, age (such as by birth date), gender, interests, contact information, home town, address, the names of the user's spouse and/or family users, educational background (such as schools, majors, etc.), employment history, skills, professional organizations, and so on. This information can be stored, for example, in the database 208.

The server 104 can also include a job poster interface 205, such as with a user interface coupled to the server 104 or via the network interface 106. The user interface can include a conventional keyboard and display configuration well known in the art. The job poster interface 205 provides an interface for the posting of jobs, including a corresponding job profile, on the social network.

The job poster interface 205 is coupled to a data management system 206. The data management system 206 can incorporate data management technologies well known in the art or can incorporate proprietary data management structures. In an example, the data management system 206 incorporates SAS, or Statistical Analysis System data management systems, to promote business analysis, statistical analysis, data storage and recovery, and the like for job, company, and employee (member) information. The data management system 206 can include the capacity for social network administrators to utilize the data generated by the data management system 206, such as by inputting tasks into the data management system 206.

The job poster interface 205 and the data management system 206 can both be coupled to the database 208. The job poster interface 205 can transmit job data, such as job profiles, to the database 208 for storage without respect to data management activities. The data management system 206 can store job data in the database 208 upon the job data having been acted upon for data management analysis.

The network interface 106 can provide the input of user data, such as user characteristics or profile data, into the social network. The user data can be stored in the database 208 or can be directly transmitted to the processing engine 200 for processing. Jobs posting and other data and results identified by or processed by the processing engine 200 can be transmitted via the network interface 106 to the user device 102 for presentation to the user.

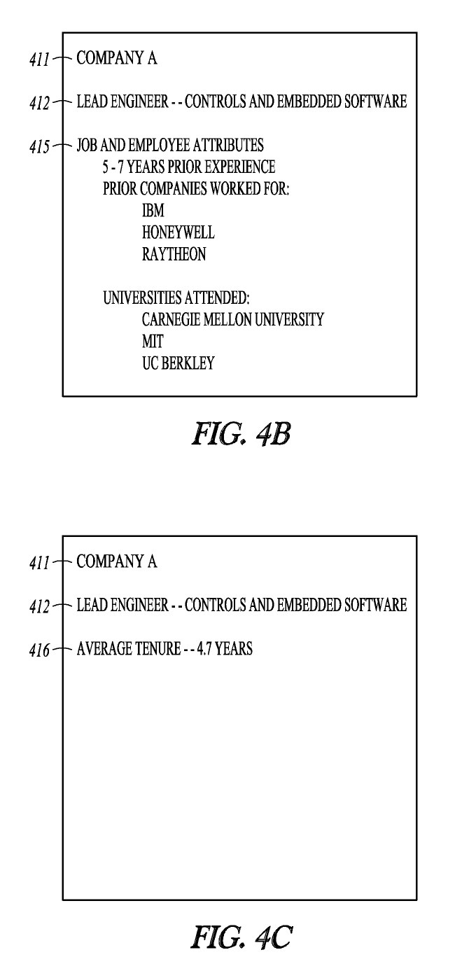

FIG. 3 is a block diagram showing some of the functional components or modules that comprise a processing engine 200, in some examples, and illustrates the flow of data that occurs when performing various operations of a method for recommending to a user of a social networking service a job posted by a business organization when an employee profile for the business organization is similar to a profile of the user, creating a job profile for a particular job title or job function at a business organization using job profiles of the business organization and member profiles, and calculating an average time period that a typical employee has had a particular job title or job function for a business organization. As illustrated, the processing engine 200 consists of two primary functional modules—an extraction engine 300 and a matching engine 302, and can be coupled to an external data source 310. The extraction engine 300 can extract data from a user profile, a company profile, an employee profile of a business organization, a job posting, and a job profile, and then operating the matching engine 302 under the direction of a particular configuration file 304 to perform a particular type of matching operation that is specific to the requesting application (such as matching an employee profile of a business organization with a user profile, wherein the job title and years of experience are weighted heavier than other attributes in the profiles). Accordingly, depending upon the particular inputs to the processing engine 200 and the desired outputs, different configuration files 304 may be used to calculate and compare different characteristics of different entities.

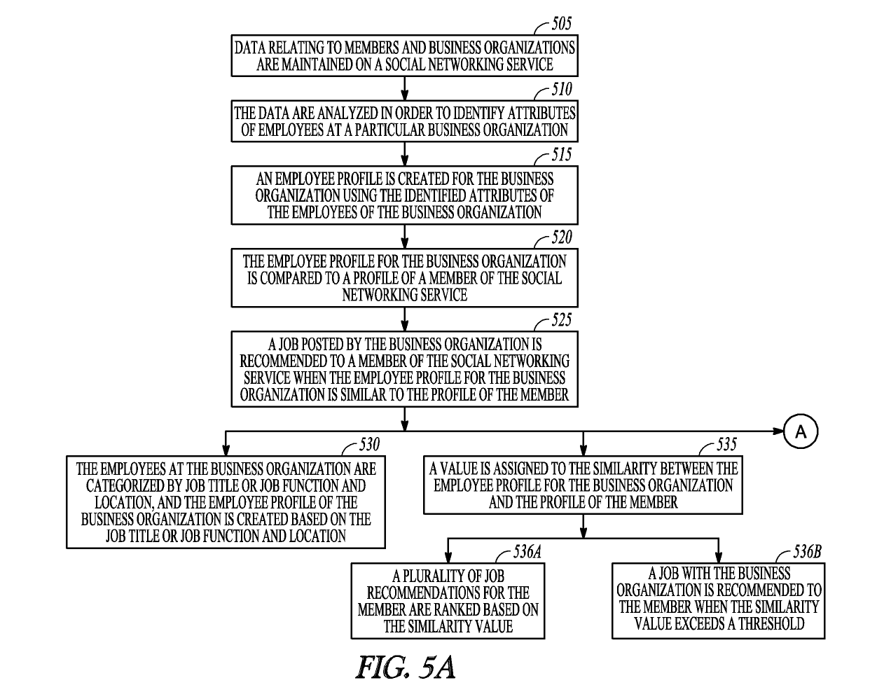

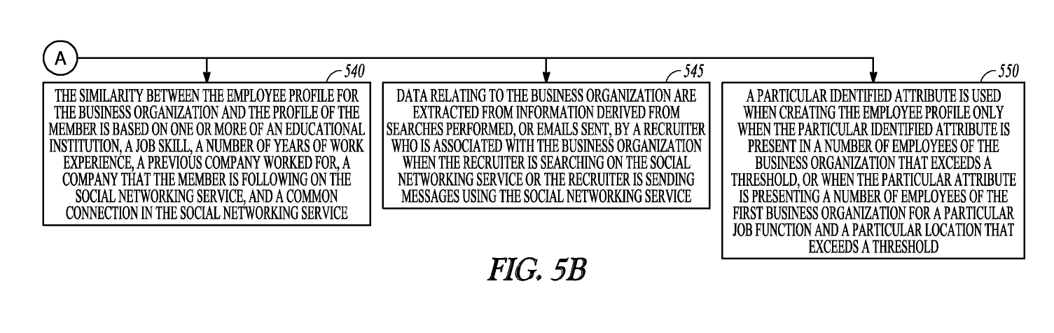

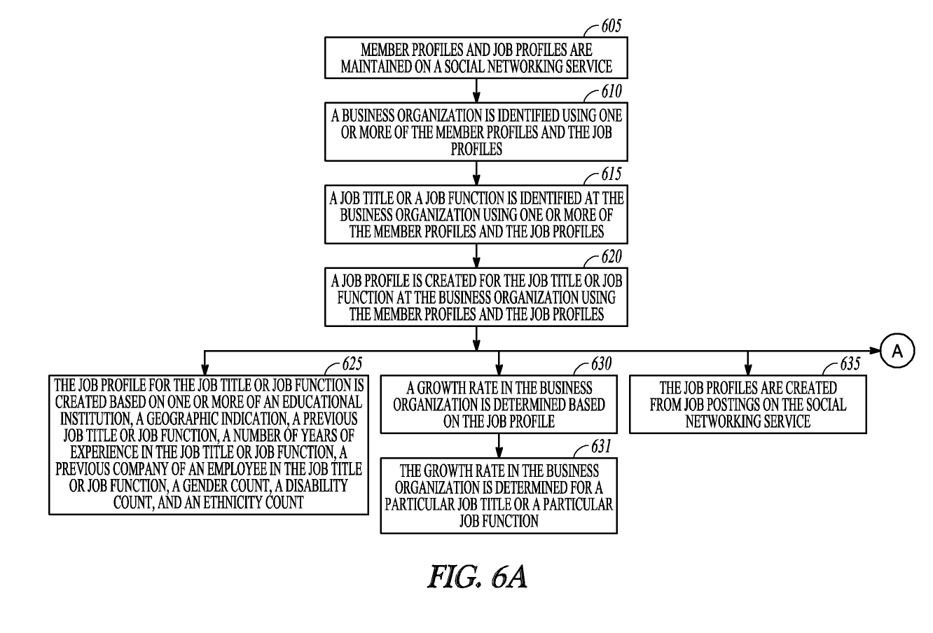

FIG. 4A is a depiction of a user interface screen 400 that can be displayed by a social network, business network, or job posting service on the user device 102 corresponding to a user. The user interface screen 400 can occupy the entire screen of the user device 102. In another example embodiment, the user interface screen 400 can be a sub-portion of a larger user interface screen displaying additional information related to the social and/or business network. Upon the processing engine 200 having identified a business organization wherein the employee profile is similar to a profile of a user of the social networking service, the social network server 104 can transmit the identifies of the business organization(s) and perhaps one or more available jobs at the business organization to the user device 102, along with other social network information that is displayed on a user interface of the user device 102. In the illustrated example, the user interface screen 400 of FIG. 4A includes a list 405 of companies 411 wherein the member profile is similar to the employee profile of the business organization. The list 405 further can include job postings 412 of the companies and job locations 413 of those job postings.

In FIG. 4B, a job profile for a job title or job function at a business organization, wherein the job profile was created using member profiles and job profiles, is displayed. The display in FIG. 4B illustrates the company 411, a particular job type or job function 412, and attributes 415 of the particular job type or job function 412 as gleaned from the member profiles and job profiles.

FIG. 4C is a user interface that displays an average time period that a typical employee has had a particular job title or job function for a business organization. The company 411 is displayed, along with the job title 412, and the average time period 416 that a typical employee at the company has had that job title.

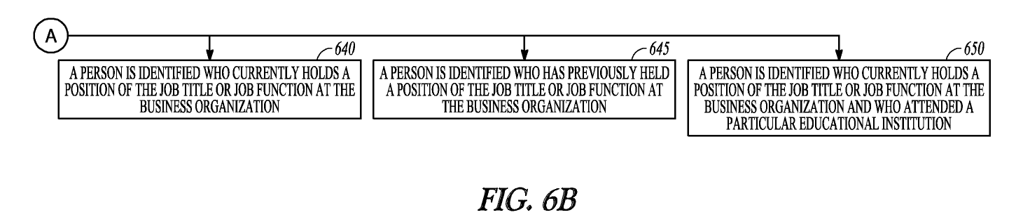

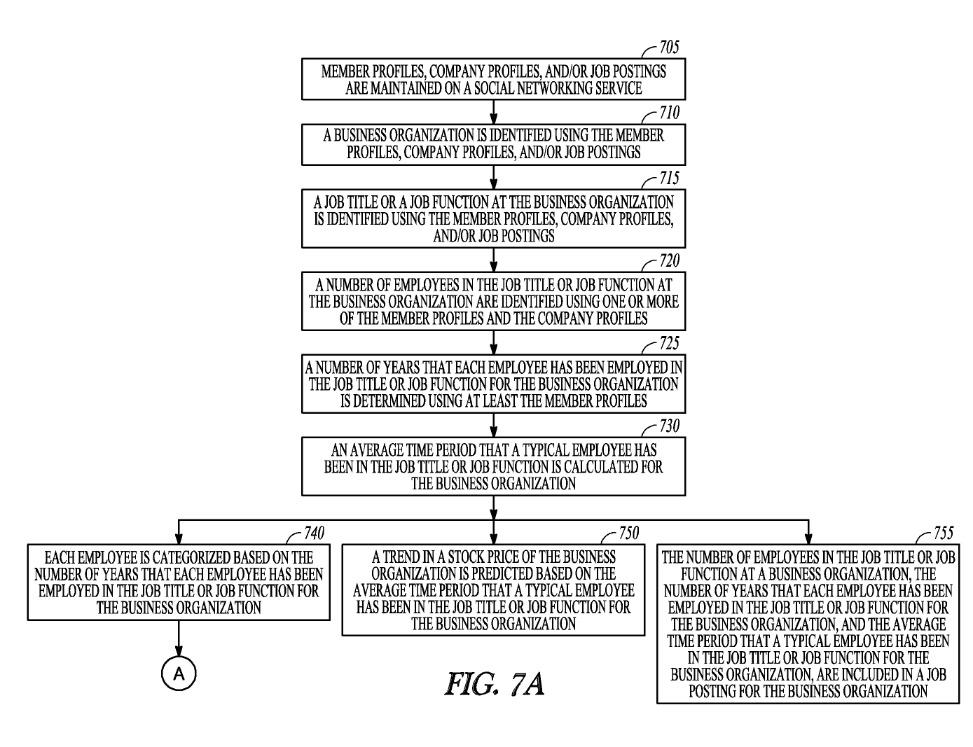

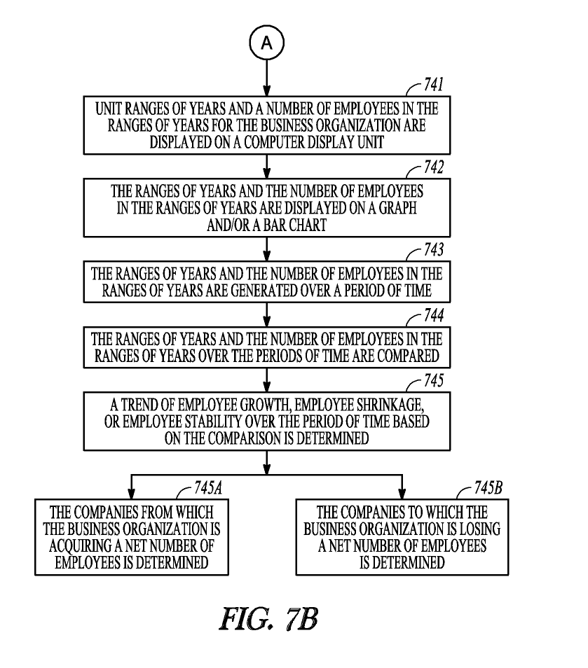

FIGS. 5A and 5B are a block diagram illustrating features of a process and system for recommending to a user of a social networking service a job posted by a business organization when an employee profile for the business organization is similar to a profile of the user. FIGS. 6A and 6B are a block diagram illustrating features of a process and system for creating a job profile for a particular job title or job function at a business organization using member profiles and job profiles. FIGS. 7A and 7B are a block diagram illustrating features of a process and system for calculating an average time period that a typical employee has had a particular job title or job function for a business organization. FIGS. 5A, 5B, 6A, 6B, 7A, and 7B include a number of process blocks 505-550, 605-650, and 705-755, respectively. Though arranged substantially serially in the examples of FIGS. 5A, 5B, 6A, 6B, 7A, and 7B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIGS. 5A and 5B, as noted, a process and system are illustrated for recommending to a user of a social networking service a job posted by a business organization when an employee profile for the business organization is similar to a profile of the user. Specifically, at 505, data relating to members and business organizations is maintained by a social networking service. The social networking service can take on several forms, including a business networking service. At 510, the data is analyzed in order to identify attributes of employees at a particular business organization. At 515, an employee profile is created for the business organization using the identified attributes of the employees of the business organization. At 520, the employee profile for the business organization is compared to a profile of a member of the social networking service. At 525, a job posted by the business organization is recommended to a member of the social networking service when the employee profile for the business organization is similar to the profile of the member. In this manner, persons who possess the attributes of many of the current employees of the business organization can be identified as a generally good fit for employment with the business organization, with or without a particular job position in mind.

While the system can function in a general sense, it can also function in a more specific sense. For example, at 530, the employees at the business organization are categorized by job title or job function. After this categorization, the employee profile of the business organization is created based on the job title or job function. In this manner, nuances of an employee profile for a particular job title or job function in the business organization can be identified and used to identify persons who are a potential good fit for the business organization for that particular job title or job function.

At 535, the system assigns a value to the similarity between the employee profile for the business organization and the profile of the member. For example, if the comparison of the business organization's employee profile to the member profile involves the comparison of ten attributes, and the member profile substantially matches eight of those attributes, then a similarity value of 0.8 can be given to the particular member. At 536A, a plurality of job recommendations for the member can be ranked based on the similarity value. This similarity value and ranking suggest to the member the business organization(s) that may be the best fit for the member. In a similar manner, after the system assigns a value to the similarity between the employee profile for the business organization and the profile of the member, at 536B, the system recommends to the member a job with the business organization when the similarity value exceeds a threshold. This embodiment can be useful to business organizations, who can indicate that they only want to consider potential job candidates who have a similarity value of at least 0.8, for example.

At 540, it is noted that the similarity between the employee profile for the business organization and the profile of the member is based on one or more of an educational institution, a job skill, a number of years of work experience, previous schools attended, a previous company worked for, a company that the member is following on the social networking service, and a common connection in the social networking service. That is, the employee profile of the business organization may indicate that many of its employees have attended a handful of particular universities, have a particular job skill such as a programming language or technology, have been in the technical field for at least a particular number of years, and have worked for one or more certain previous companies. The similarity can also be affected if the member has been following the business organization on social media, or has some sort of connection with the business organization on social media (such as the member is connected to at least ten employees of the business organization).

At 545, the system extracts the data relating to the business organization from information derived from searches performed, or emails sent, by a recruiter who is associated with the business organization when the recruiter is searching on the social networking service or the recruiter is sending messages using the social networking service. So, in addition to gleaning the data required for the employee profile of the business organization from member profiles of the employees of the business organization, the data can be gleaned from a recruiter's efforts to locate persons for employment at the business organization. This embodiment permits a construction of an employee profile of a business organization not so much based on the current employee makeup of the business organization, but on what type of potential employees the business organization is currently looking for.

At 550, the system, in creating the employee profile for the business organization using the identified attributes of the employees of the business organization, uses a particular identified attribute when creating the employee profile only when the particular identified attribute is present in a number of employees of the business organization that exceeds a threshold. In another embodiment, the employee profile for the business organization will not be created until a minimum number of employee profiles are available, so that there is a sufficient population before any inferences are drawn about a specific attribute. For example, to be considered a general or significant attribute of an employee of the business organization, the system may require that at least 50% of its employees possess this attribute, or at least a certain number of employees to work in that job function and location before inferences on an attribute are derived. In contrast, if less than 50% of the employees possess an attribute, it may not be considered an attribute that is necessarily, particularly favored by the business organization, or if less than a certain number of employees are within a job function or at a location, then no inferences about that attribute will be drawn.

Referring now to FIGS. 6A and 6B, as noted, a system and process are illustrated for creating a job profile for a particular job title or job function at a business organization using member profiles and job profiles. Specifically, at 605, member profiles and job profiles are maintained on a social networking service. At 610, a business organization is identified using one or more of the member profiles and the job profiles. At 615, a job title or a job function is identified at the business organization using one or more of the member profiles and the job profiles. And at 620, a job profile is created for the job title or job function at the business organization using the member profiles and the job profiles.

At 625, the system creates the job profile for the job title or job function based on one or more of an educational institution, a geographic indication, a previous job title or job function, a number of years of experience in the job title or job function, a previous company of an employee in the job title or job function, a gender count, a disability count, and an ethnicity count. That is, the created job profile can indicate that many employees in this job title or job function at the business organization have attended a handful of particular universities, are located in a particular geographic area, have a particular job skill such as a programming language or technology, have been in the technical field for at least a particular number of years, and have worked for a handful of previous companies. The job profile can also indicate that the majority of its employees are male, are female, have or do not have a disability, or are or are not of a particular ethic background.

At 630, the system determines a growth rate in the first business organization based on the job profile. For example, if it is known within the business or technology community that a particular technology is in a growth mode, and the job profile of the business organization shows a large population of employees in that technology (or shows an increase of employees in that technology in the recent past), it can be concluded that the business organization is in a growth mode in that particularly attractive technology. At 631, the system determines the growth rate in the business organization for a particular job title or a particular job function, such as for example mobile communications.

At 635, the system creates the job profiles from job postings on the social networking service. In this embodiment, the system does not have to depend on having access to any closely held data of the business organization. Rather, the system, from the public postings of the business organization, can determine a job profile of the business organization. At 640, the system identifies a person who currently holds a position of the job title or job function at the business organization. The information gained from this feature can be used for many purposes, such as identifying a person of a particular skill set who may be sought after by other business organizations, or identifying a contact point at a business organization who may be approached to determine if his or her business organization is currently looking for other people in that technology area. At 645, the system identifies a person who has previously held a position of the job title or job function at the business organization. The information from this feature can be used in a manner similar to the information that was acquired in block 640. That is, the information can be used to identify a person of a particular skill set who may be sought after by other business organizations, or to identify a contact point at a business organization who may be approached to determine if his or her business organization is currently looking for other people in that technology area. At 650, the system identifies a person who currently holds a position of the job title or job function at the business organization and who attended a particular educational institution. This feature specifically identifies a person at the business organization who attended a particular educational institution, and this information can be used to seek out this person for employment at other business organizations who tend to hire people who matriculated at that educational institution, or to try to find jobs in the business organization for people who attended the same business organization.

Referring now to FIGS. 7A and 7B, as noted above, a system and process are illustrated for calculating an average time period that a typical employee has had a particular job title or job function for a business organization. At 705, member profiles, company profiles, and/or job postings are maintained on a social networking service. Member profiles relate to personal and professional data about members or users of the social networking service. Company profiles relate to information about business organizations that have accounts or pages with the social networking service. Job postings relate to job openings that are posted by the social networking service on behalf of a business organization.

At 710, a business organization is identified using the member profiles, company profiles, and/or job postings. This identification can occur by seeing that a member profile discloses that the member works or has worked for the business organization, examining the company profile of the business organization, or seeing that the business organization posted a particular job opening.

At 715, a job title or a job function at the business organization is identified using the member profiles, company profiles, and/or job postings. This identification can occur by seeing from a member profile that a member holds or has held a certain job title at the business organization, that the company profile discloses the job title within its organization, and/or that the job posting of the business organization is seeking one or more persons for a particular job title.

At 720, a number of employees in the job title or job function at the business organization are identified using one or more of the member profiles and the company profiles. The company profile may provide this data by directly reporting it. The use of the member profiles to uncover these data may take more effort, and may depend on all or at least a vast majority of the employees in the job title also being members of the social networking service.

At 725, a number of years that each employee has had the job title or job function for the business organization is determined using at least the member profiles. These data can be obtained by examining the past and current employment history in each of the members' profiles for the business organization, and calculating the length of time that each employee has been employed in the job title or job function.

At 730, an average time period that a typical employee has had the job title or job function is calculated for the business organization. These data can be used for several functions, such as determining the depth of experience in a particular job title, function, or technical area for the business organization.

At 740, each employee is categorized based on the number of years that each employee has been employed in the job title or job function for the business organization. For example, categories can include 1-5 years, 6-10 years, 11-15 years, etc. At 741, unit ranges of years and a number of employees in the ranges of years for the business organization are displayed on a computer display unit. For example, the ranges can indicate that the business organization has 12 employees in the 1-5 years range, 16 employees in the 6-10 years range, and 8 employees in the 11-15 years range. In an embodiment, as indicated at 742, the ranges of years and the number of employees in the ranges of years are displayed on a graph and/or a bar chart. At 743, the ranges of years and the number of employees in the ranges of years are generated over a period of time. At 744, the ranges of years and the number of employees in the ranges of years over the periods of time are compared, and at 745, a trend of employee growth, employee shrinkage, or employee stability over the period of time based on the comparison is determined. At 745A, the companies from which the business organization is acquiring a net number of employees is determined, and at 745B, the companies to which the business organization is losing a net number of employees is determined.

At 750, a trend in a stock price of the business organization is predicted based on the average time period that a typical employee has had a particular job title or job function for the business organization. The greater the average time that employees have been in a particular job title or job function, the greater the brain trust or wealth of the company, and the greater the chance that the stock price of the company will rise in the future. In an embodiment, predicting the price of the stock of the business organization can consider other factors such as the number of employees in a particular job function and the market need for the particular job function. For example, if there are a good number of employees in the function of software system security breaches, and such breach protection is becoming more prevalent and more important in the IT community, the system can predict that the stock price of the company will rise in the foreseeable future.

As noted above, the number of employees having the job title or job function at a business organization can be determined, the number of years that each employee has been employed in the job title or job function for the business organization can be determined, and the average time period that a typical employee has had the particular job title or job function for the business organization can be determined. In an embodiment, at 755, the number of employees having the job title or job function at a business organization, the number of years that each employee has had the job title or job function for the business organization, and the average time period that a typical employee has had a particular job title or job function for the business organization are included in a job posting for the business organization.

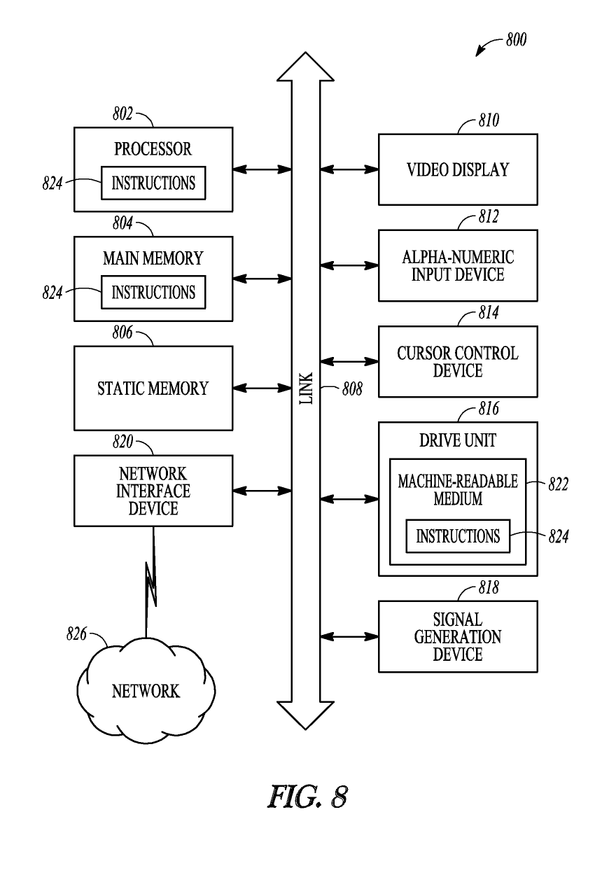

FIG. 8 is a block diagram illustrating components of a machine 800, according to some example examples, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software) for causing the machine 800 to perform any one or more of the methodologies discussed herein may be executed. In alternative examples, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A memory device, the memory device communicatively coupled to a processor and comprising instructions which, when performed on the processor, cause the processor to:
maintain one or more of member profiles, company profiles, and job postings on a social networking service;
identify a business organization using the one or more of member profiles, company profiles, and job postings;
identify a job title or a job function at the business organization using the one or more of member profiles, company profiles, and job postings;
identify a number of employees in the job title or job function at the business organization using one or more of the member profiles and the company profiles;
determine a number of years that each employee has been employed in the job title or job function for the business organization using at least the member profiles; and
calculate an average time period that a typical employee has been in the job title or job function for the business organization.

2. The memory device of claim 1, comprising instructions to cause the processor to categorize each employee based on the number of years that each employee has been employed in the job title or job function for the business organization; and to display on a computer display unit ranges of years and a number of employees in the ranges of years for the business organization.

3. The memory device of claim 2, comprising instructions to cause the processor to display the ranges of years and the number of employees in the ranges of years on one or more of a graph and a bar chart.

4. The memory device of claim 2, comprising instructions to cause the computer processor to generate the ranges of years and the number of employees in the ranges of years over a period of time; to compare the ranges of years and the number of employees in the ranges of years over the periods of time; and to determine a trend of employee growth, employee shrinkage, or employee stability over the period of time based on the comparison.

5. The memory device of claim 4, comprising instructions to cause the computer processor to determine one or more companies from which the business organization is acquiring a net number of employees; and to determine one or more companies to which the business organization is losing a net number of employees.

6. The memory device of claim 1, comprising instructions to cause the computer processor to predict a trend in a stock price of the business organization based on the average time period that a typical employee has been in the job title or job function for the business organization.

7. The memory device of claim 1, wherein one or more of the number of employees in the job title or job function at the business organization, the number of years that each employee has been employed in the job title or job function for the business organization, and the average time period that a typical employee has been in the job title or job function for the business organization, are included in a job posting for the business organization.

8. A process comprising:
maintaining one or more of member profiles, company profiles, and job postings on a social networking service;
identifying a business organization using the one or more of member profiles, company profiles, and job postings;
identifying a job title or a job function at the business organization using the one or more of member profiles, company profiles, and job postings;
identifying a number of employees in the job title or job function at the business organization using one or more of the member profiles and the company profiles;
determining a number of years that each employee has been employed in the job title or job function for the business organization using at least the member profiles; and
calculating an average time period that a typical employee has been in the job title or job function for the business organization.

9. The process of claim 8, comprising categorizing each employee based on the number of years that each employee has been employed in the job title or job function for the business organization; and displaying on a computer display unit ranges of years and a number of employees in the ranges of years for the business organization.

10. The process of claim 9, comprising displaying the ranges of years and the number of employees in the ranges of years on one or more of a graph and a bar chart.

11. The process of claim 9, comprising generating the ranges of years and the number of employees in the ranges of years over a period of time; comparing the ranges of years and the number of employees in the ranges of years over the periods of time; and determining a trend of employee growth, employee shrinkage, or employee stability over the period of time based on the comparison.

12. The process of claim 11, comprising determining one or more companies from which the business organization is acquiring a net number of employees; and determining one or more companies to which the business organization is losing a net number of employees.

13. The process of claim 8, comprising predicting a trend in a stock price of the business organization based on the average time period that a typical employee has been in the job title or job function for the business organization.

14. The process of claim 8, wherein one or more of the number of employees in the job title or job function at the business organization, the number of years that each employee has been employed in the job title or job function for the business organization, and the average time period that a typical employee has been in the job title or job function for the business organization, are included in a job posting for the business organization.

15. A system comprising:
a computer processor operable for:
maintaining one or more of member profiles, company profiles, and job postings on a social networking service;
identifying a business organization using the one or more of member profiles, company profiles, and job postings;
identifying a job title or a job function at the business organization using the one or more of member profiles, company profiles, and job postings;
identifying a number of employees in the job title or job function at the business organization using one or more of the member profiles and the company profiles;
determining a number of years that each employee has been employed in the job title or job function for the business organization using at least the member profiles; and
calculating an average time period that a typical employee has been in the job title or job function for the business organization.

16. The system of claim 15, comprising a computer processor operable for categorizing each employee based on the number of years that each employee has been employed in the job title or job function for the business organization; and displaying on a computer display unit ranges of years and a number of employees in the ranges of years for the business organization.

17. The system of claim 16, comprising a computer processor operable for displaying the ranges of years and the number of employees in the ranges of years on one or more of a graph and a bar chart.

18. The system of claim 16, comprising a computer processor operable for generating the ranges of years and the number of employees in the ranges of years over a period of time; comparing the ranges of years and the number of employees in the ranges of years over the periods of time; and determining a trend of employee growth, employee shrinkage, or employee stability over the period of time based on the comparison.

19. The system of claim 18, comprising a computer processor operable for determining one or more companies from which the business organization is acquiring a net number of employees; and determining one or more companies to which the business organization is losing a net number of employees.

20. The system of claim 15, comprising a computer processor operable for predicting a trend in a stock price of the business organization based on the average time period that a typical employee has been in the job title or job function for the business organization.

21. The system of claim 15, wherein one or more of the number of employees in the job title or job function at the business organization, the number of years that each employee has been employed in the job title or job function for the business organization, and the average time period that a typical employee has been in the job title or job function for the business organization, are included in a job posting for the business organization.
